(19) United States
(12) Patent Application Publication
(10) Pub. No.: US 2005/0156090 A1
(43) Pub. Date: Jul. 21, 2005

(54) Musical instrument harness and anchoring system

(76) Inventor: Clarence R. Drayton JR., Altadena, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/993,203

(22) Filed: Nov. 19, 2004

Related U.S. Application Data
(60) Provisional application No. 60/524,354, filed on Nov. 20, 2003.

(51) Int. Cl. A47G 29/00; A47B 91/00; G10D 13/02; G10G 1/00; F16M 11/00

(52) U.S. Cl. 248/346.03; 248/690; 84/421; 84/453

(57) ABSTRACT

A musical instrument stabilizer. A musical instrument such as a bass drum and/or high hat can be stabilized by a strip with a circular cup at one end. The strip can be secured to a bottom surface of a drum pedal using respective male and female Velcro strips. Thus, a musician can play the musical instruments without movement thereof.

### CROSS REFERENCE TO RELATED APPLICATIONS

The present application claims priority to Provisional Application 60/524,354, filed on Nov. 20, 2003, which is incorporated by reference herein in its entirety.

### BACKGROUND OF THE INVENTION

1. Field of the Invention

The present invention is directed to an apparatus and method to secure musical instruments while being played.

2. Description of the Related Art

U.S. Pat. No. 5,667,502 is directed towards a drum anchor using a female Velcro base taped to the floor to which is anchored a male Velcro. The male Velcro is part of an assembly using a screw assembly which simply attaches to the bass drum to be held in place on the front and along each side of the drum on two positions with the use of a swivel strap to hold the entire unit in place.

U.S. Pat. No. 5,054,357 is directed towards a marching percussion instrument stand that has a new and useful improvement for mounting percussion instruments to a stand by a musician-member of a marching band. The device includes a plurality of vertical mounting bars, supported by, and attached in an offset position above horizontally disposed support bars or feet.

While there have been a number of patents directed to stabilizing instruments, there is a need for a way in which unstable instruments, such as a bass drum and high hat, can be stabilized while playing them.

### SUMMARY OF THE INVENTION

It is an aspect of the present invention to provide an apparatus and method to stabilize musical instruments while playing them.

The above aspects can also be obtained by an apparatus that includes: (a) a cup holder to receive a leg of a seat; and (b) a narrow strip attached to the cup holder with a first connection device attached on a topside of the narrow strip.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a front view of the present invention, according to an embodiment;

FIG. 2 is a side view of the present invention, according to an embodiment;

FIG. 3 is a top view of the present invention, according to an embodiment; and

FIG. 4 is a perspective view of the present invention, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present invention relates to a system that can stabilize movement of a bass drum/high hat by harnessing and anchoring the drum seat to the bass drum/high hat pedal, linking all three into one complete unit. Thus, while the drum/high hat is being played, they will be restrained from movement and the musician can concentrate on playing.

A leg of a drum seat can be inserted into a cup which is attached to a strip. The strip can be attached to a male (or female) Velcro strip. The bass drum/high hat pedal can be strapped to the device by applying female (or male) Velcro to an underside of the drum/hat pedal. The male and female Velcro strips can then be joined together, linking the bass drum/high hat pedal to the drum seat, thereby using the weight of the drummer on the seat to hold the drum/high hat firmly in place. The drum/high hat is therefore prevented from moving forward or sliding while being beaten.

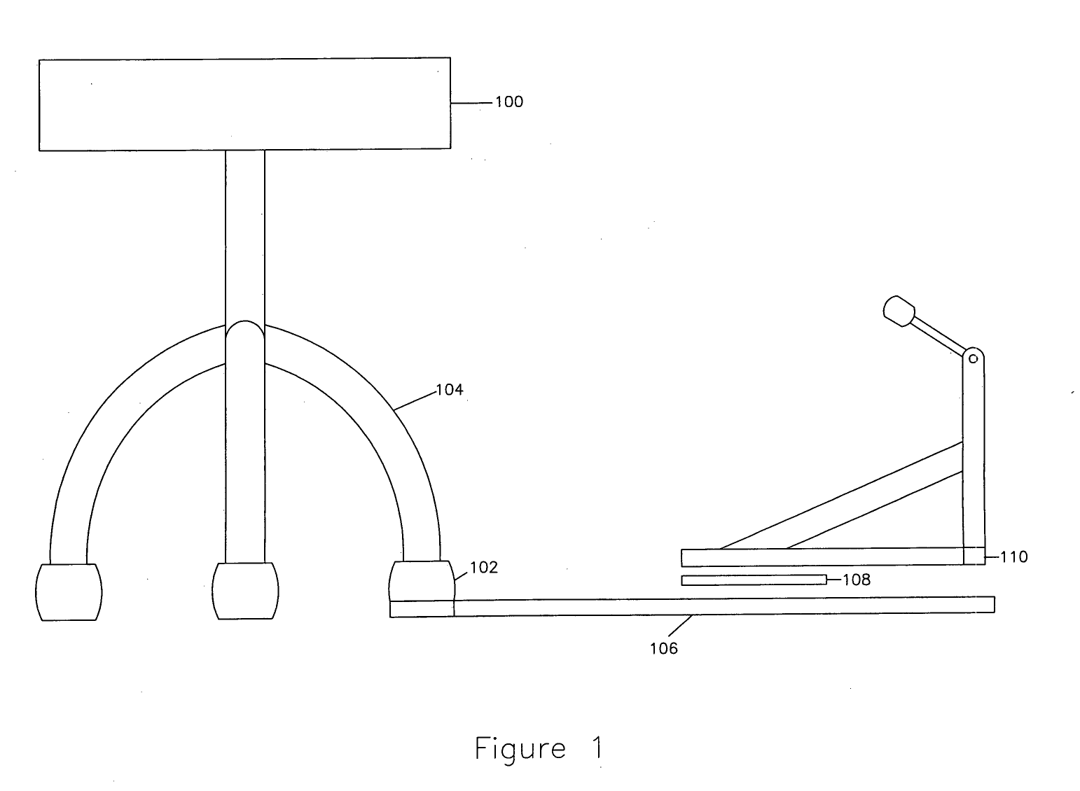

FIG. 1 is a front view of the present invention, according to an embodiment.

A seat 400 has a leg 104 (e.g. a rubber foot) which is snugly inserted into a cup 102. The cup 102 is attached to a narrow strip 106. The narrow strip 106 contains a first Velcro strip (not pictured) attached to the narrow strip 106. A second Velcro strip 108 can be attached to a pedal 110. Thus, the first Velcro strip and the second Velcro strip 108 secure the pedal 110 to the narrow strip 106 which is in turn secured to the seat 100 by having the leg 104 of the seat 100 inserted into cup 102.

The forward motion generated by pressing down on the pedal 110 by the musician is now prevented from disturbing a position of the pedal 110.

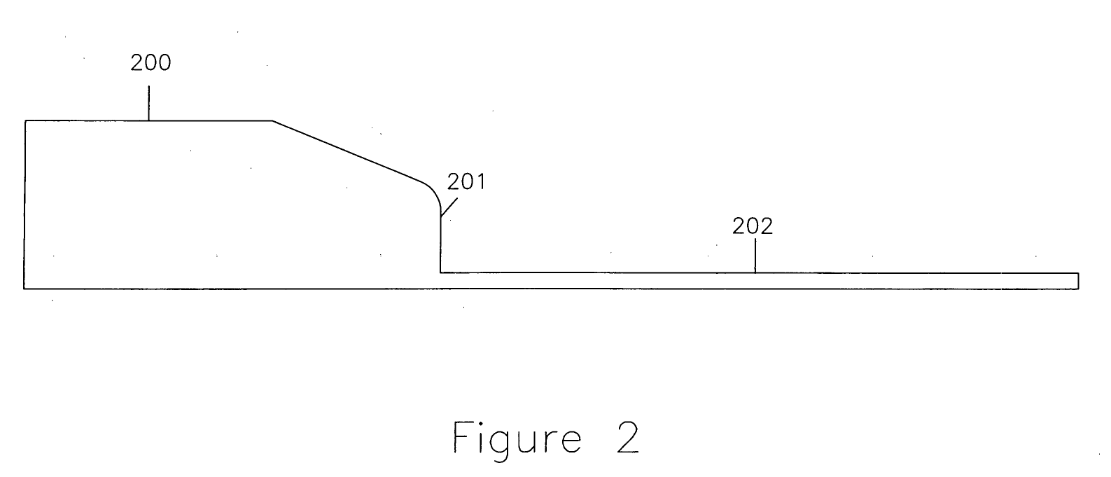

FIG. 2 is a side view of the present invention, according to an embodiment.

A cup unit is used to receive a leg of a seat or chair. A narrow strip 202 is secured to the cup unit 200. The cup unit can include a cup 200 and an optional cup connection portion 201, which bridges between the cup 200 and the narrow strip 202.

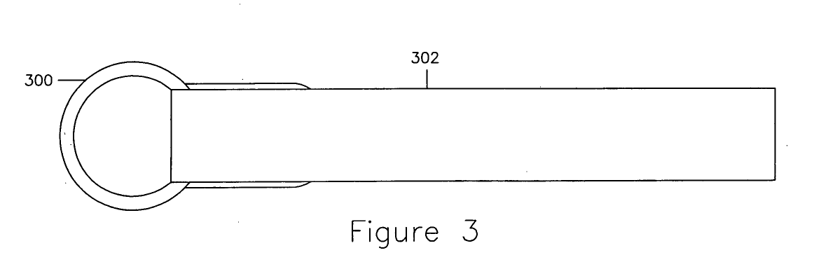

FIG. 3 is a top view of the present invention, according to an embodiment.

A narrow strip 302 is attached to a cup unit 300 which is used to receive a leg of a seat.

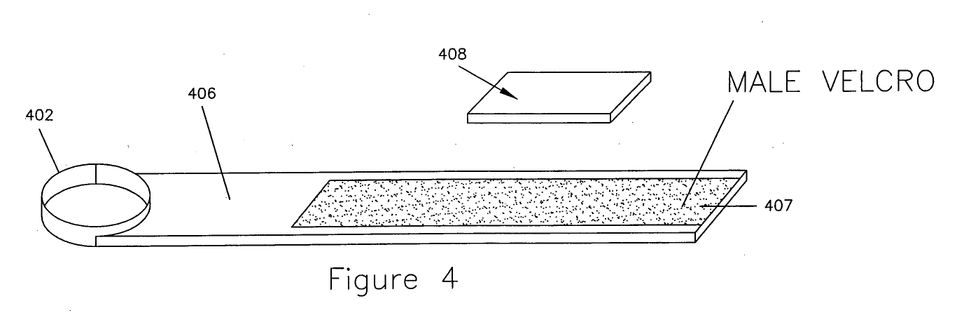

FIG. 4 is a perspective view of the present invention, according to an embodiment.

A cup 402 is connected to a narrow strip 406 which contains a male (or female) Velcro strip 407. The male Velcro strip 407 can be 4 inches (or any other length) from the cup 402. A female (or male) Velcro strip 408 is securely attached (e.g. by using glue or any other known Velcro attaching mechanism) to a bottom side of a pedal (or other musical instrument) (not pictured). The female Velcro strip 408 sticks to the male Velcro strip 407, thereby securing the pedal to the narrow strip 406.

The cup diameter can be about 2¼ inches. A height of the cup can be about 1¼ inches. The thickness of a perimeter of the cup can be ⅛ inch. The width of the narrow strip can be 1¼ inches. The length of the narrow strip can be 13¾ inches. A height of the narrow strip can be ⅛ inch. A length of the entire cup unit (the cup plus the connecting portion) can be 13¾ inches. The length can also be 15-18″ or any length. The narrow strip can be made of any material, such as stainless steel and/or nylon. A height of the vertical cup connection portion before it begins to slope (as illustrated in FIG. 2) can be ½ inch (not including the ⅛ inch height of the strip). Of course, these measurements are exemplary, and other measurements and sizes can be used as well.

Further, while Velcro strips have been identified herein as the connection mechanism to connect the narrow strip to the pedal, it is noted that other connection mechanisms can be used as well, such as snaps, screws, buttons, suction, and any other known connection device.

Moreover, the securing system described herein can be used for other purposes aside from securing a musical instrument. It can also be used to secure sewing pedals, pedals for an electronic keyboard (or other electronic instrument), or any other pedal driven device. Generally, the securing system of the present invention secures a component (any device, such as a pedal driven device) to a seat or other fixed object.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A restraining apparatus, the apparatus comprising:
a cup holder to receive a leg of a seat; and
a narrow strip attached to the cup holder with a first connection device attached on a topside of the narrow strip.

2. An apparatus as recited in claim 1, further comprising:
a component with a bottom side, the bottom side attached to a second connection device adapted to attach to the first connection device.

3. An apparatus as recited in claim 1, wherein the first connection device is a Velcro strip.

4. An apparatus as recited in claim 2, wherein the first connection device is a Velcro strip, and the second connection device is a Velcro strip adapted to stick to the first connection device.

5. An apparatus as recited in claim 2, wherein the component is a pedal.

6. An apparatus as recited in claim 5, wherein the pedal plays a musical instrument.

7. An apparatus as recited in claim 6, wherein the musical instrument is a bass drum.

8. An apparatus as recited in claim 6, wherein the musical instrument is a high hat cymbal.

9. An apparatus as recited in claim 5, wherein the pedal is used for a sewing machine.

10. An apparatus as recited in claim 5, wherein the pedal is used for an electronic musical instrument.

11. An apparatus as recited in claim 4, wherein the component is a pedal.

12. An apparatus as recited in claim 11, wherein the pedal plays a musical instrument.

13. An apparatus as recited in claim 12, wherein the musical instrument is a bass drum.

14. An apparatus as recited in claim 13, wherein the musical instrument is a high hat cymbal.

15. An apparatus as recited in claim 11, wherein the pedal is used for a sewing machine.

16. An apparatus as recited in claim 11, wherein the pedal is used for an electronic musical instrument.

17. A restraining apparatus, the apparatus comprising:
an attachment means to attach to a seat; and
a connection means to connect a musical instrument to the attachment means, thereby preventing movement of the musical instrument.
